(19) United States
(12) Patent Application Publication
(10) Pub. No.: US 2017/0254109 A1
(43) Pub. Date: Sep. 7, 2017

(54) COLLAPSIBLE CANOPY SYSTEM

(71) Applicant: Kenneth G. Colbo, Missoula, MT (US)

(72) Inventor: Kenneth G. Colbo, Missoula, MT (US)

(21) Appl. No.: 15/448,413

(22) Filed: Mar. 2, 2017

Related U.S. Application Data
(60) Provisional application No. 62/302,543, filed on Mar. 2, 2016.

(51) Int. Cl. E04H 15/20; H02S 40/38; H02J 7/35; E04H 15/06; B62B 5/00

(52) U.S. Cl. CPC E04H 15/20; E04H 15/06; B62B 5/0013; H02J 7/355; H02S 40/38; E04H 2015/206

(57) ABSTRACT

A collapsible canopy system comprises an inflatable canopy cover, which may itself comprise a plurality of inflatable frame members, the frame members forming a top frame having a first end and a second end, and a back frame having a first end and a second end, the first end of the top frame being attached to the first end of the back frame and one or more flexible shade panels, wherein at least one of the flexible shade panels is disposed between the plurality of frame members forming the top frame. The system may comprise a canopy housing itself comprising an air pump configured to pump air into at least a portion of the inflatable canopy cover, a mechanism for attaching the canopy housing to another object, and a storage compartment configured to retain the inflatable canopy cover when it is in a deflated state.

### PRIORITY

This application claims priority to U.S. Provisional Application No. 62/302,543, filed Mar. 2, 2016, and entitled KART KANOPY, which is incorporated herein by reference.

### FIELD OF THE DISCLOSURE

The present disclosure relates generally to a protective canopy and associated housing. In particular, but without limitation, the present disclosure relates to a collapsible and retractable canopy that may protect a user from sun, rain, or other objects and may be attached to other objects, such as golf carts.

### BACKGROUND OF THE DISCLOSURE

In recent years, wheeled push carts for carrying golf bags have become popular with golfers who walk golf courses. These golf push carts typically have three or four wheels that form a stable base and hold a golf bag at an angle of approximately 45 degrees. They also typically have a handle extending from an area near the top of the golf bag that can be used to push the cart and to attach accessories. For the purposes of the present disclosure, the term “golf carts” may be used to refer to these types of carts, rather than to motorized driving golf carts in which a driver and one or more passengers can sit.

Some golf carts have an umbrella holder as an accessory attached to the handle, in recognition of the need golfers have for rain and sun protection. Sun protection is especially crucial since the sunniest days encourage golfers to stay out for many hours. As golfers become more aware of the risks of excessive sun exposure, such as skin cancer, more golfers require adequate sun protection while golfing. While an umbrella can provide some protection, there are some limitations to its effectiveness in an umbrella holder. One main limitation is that the area of shade provided by the umbrella changes size, shape, and location based on the position of the sun. When a golfer is stationary and not moving the golf cart, the golfer may position him or herself in the shade, but when the golfer is pushing the cart, he or she must necessarily stand and walk near the handle. This location may be underneath the umbrella, but the shade cast by the umbrella may be in a different location, and the golfer may still be exposed to direct sunlight. Another limitation to umbrellas in umbrella holders is that they are prone to being blown away even in light winds. It is also impractical for a golfer to hold an umbrella in hand while pushing a golf cart. Therefore, a need exists for convenient, lightweight protective covers that remedy these problems. A need exists for apparatuses that can be conveniently attached to objects, including golf carts, to provide adequate shade and other protection for users.

### SUMMARY

One aspect of the present disclosure provides a collapsible protective canopy comprising a plurality of inflatable frame members, the frame members forming a rectangular top frame having a first end and a second end, and a rectangular back frame having a first end and a second end, the first end of the rectangular top frame being attached to the first end of the rectangular back frame. The protective canopy may further comprise at least one diagonal frame member attached to the second end of the rectangular top frame and the second end of the rectangular back frame. The canopy may further comprise one or more flexible shade panels, wherein at least one of the flexible shade panels is disposed between the plurality of frame members forming the rectangular top frame.

Another aspect of the disclosure provides a collapsible canopy system, which may comprise an inflatable canopy cover. The inflatable canopy cover may itself comprise a plurality of inflatable frame members, the frame members forming a top frame having a first end and a second end, and a back frame having a first end and a second end. The first end of the top frame may be attached to the first end of the back frame. The inflatable canopy may comprise one or more flexible shade panels, wherein at least one of the flexible shade panels is disposed between the plurality of frame members forming the top frame. The system may also comprise a canopy housing, which itself may comprise an air pump configured to pump air into at least a portion of the inflatable canopy cover, a mechanism for attaching the canopy housing to another object, and a storage compartment configured to retain the inflatable canopy cover when it is in a deflated state.

### BRIEF DESCRIPTION OF THE DRAWINGS

FIG. 1 shows a canopy system of the present disclosure comprising a canopy cover in an inflated configuration attached to a canopy housing.

FIG. 2 shows a back perspective view of a canopy cover in accordance with an embodiment of the present disclosure.

FIG. 3 shows a front perspective view of the canopy cover of FIG. 2

FIG. 4 shows a back side elevation view of the canopy cover of FIG. 2

FIG. 5 shows a left side elevation view of the canopy cover of FIG. 2

FIG. 6 shows a right side elevation view of the canopy cover of FIG. 2

FIG. 7 shows a top plan view of the canopy cover of FIG. 2

FIG. 8 shows a front elevation view of the canopy cover of FIG. 2

FIG. 9 shows an exemplary canopy housing apparatus in accordance with the present disclosure retaining a canopy cover in a deflated position.

FIG. 10 shows an exemplary canopy housing apparatus in accordance with the present disclosure with some interior components exposed.

### DETAILED DESCRIPTION

All illustrations of the drawings are for the purpose of describing embodiments of the present disclosure, and are not intended to limit its scope. The following description may be best understood with reference to the accompanying numbered figures.

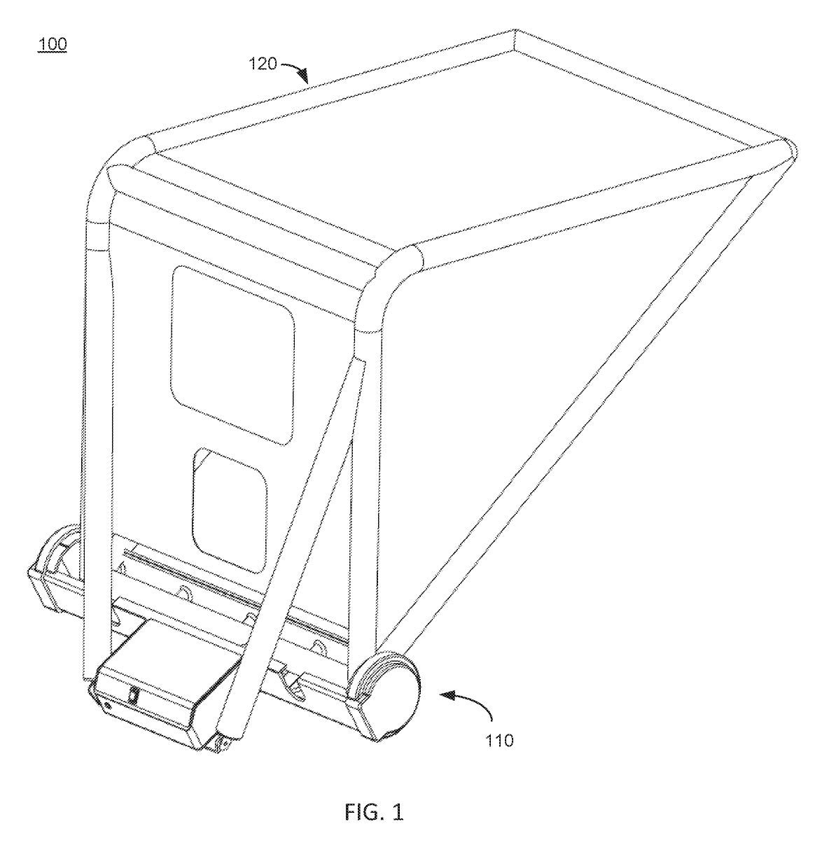

FIG. 1 shows an embodiment of a collapsible canopy system 100 in accordance with the present disclosure. The collapsible canopy system 100 (which may also be referred to solely as a “canopy system”) shown comprises a canopy housing 110, which will be described in further detail later in the disclosure, and a canopy cover 120 disposed thereon. The canopy cover 120 may be inflatable, flexible, and collapsible into a storage configuration. The mechanism for inflating, collapsing, and storing of the canopy cover 120 will be described in detail later in the disclosure. The collapsible canopy system 100 may be particularly suitable for attachment to a handle of a golf cart, and its overall design may provide many advantages when used in conjunction with a golf cart; however, the collapsible canopy system 100 of the present disclosure should not be construed to be limited to such uses. The canopy system 100 may be attached to other objects or surfaces, such as a stroller or a stationary rail, for example. The canopy cover 120 is shown in its fully inflated configuration and attached to the canopy housing 110 in FIG. 1.

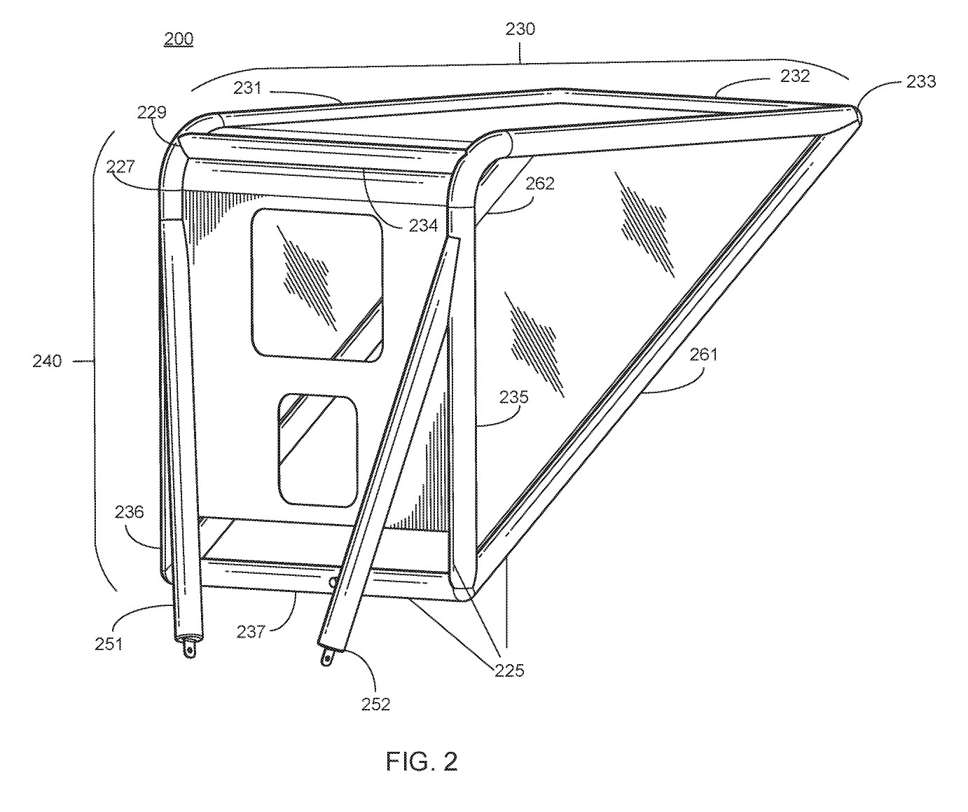

FIG. 2 shows a perspective view of the canopy cover 200 (similar to canopy cover 120 of FIG. 1) by itself. As shown, it comprises a frame 225, which itself may comprise a plurality of “structural frame members” (231-237) and two “diagonal frame members,” (261, 262) as they may be referred to throughout the disclosure. Each of the frame members may comprise substantially hollow, flexible, collapsible tubes. These hollow tubes may be configured as a plurality of individual segments joined together, and be made of fabric, plastics, polymers, or other suitable flexible material. The seams (e.g., seams 227, 229) show where individual segments may be joined together by stitching, welding, gluing, or any other form of attachment. In other embodiments, the hollow tubes may be formed by a unitary construction, or segments may be joined together at different locations.

In the configuration shown, the frame 225 of the canopy cover 220 may comprise top frame members (structural frame members) 231, 232, 233, and 234, which form a “top frame” 230. In the embodiment shown, the top frame 230 is rectangular, but it is contemplated that in other embodiments, the top frame may form a different geometrical shape (e.g., rounded or curved in parts). The frame 225 may further comprise back frame members 235, 236, and 237, which together with top frame member 234 form a back frame 240. In the embodiment shown, the back frame 240 is rectangular, but it may be shaped differently in other embodiments. The back frame 240 may be attached to two mounting frame members 251 and 252. The mounting frame members 251 and 252 may be attached to back frame member 137 as well as to back frame members 235 and 236 for structural support. In some embodiments, the attachment points may allow air to flow from the mounting frame members 251 and 252 and into back frame members 235, 236, and 237 to inflate them.

The top frame 230 and back frame 240 may be supported at a substantially right angle in relation to one another by diagonal frame members 261 and 262. In other embodiments, the angle between the top frame and back frame may be more obtuse or acute. The space between the diagonal members 261 and 262 may form a front opening, within which a user may stand in the shade provided by the canopy cover 200. The diagonal members 261 and 262 are shown attached at approximately 45 degree angles from the top frame 230 and back frame 240, but in other embodiments, they may be arranged at different angles.

It is contemplated that in some embodiments, each of the individual frame members may be hollow and inflatable. However, in other embodiments, some of the frame members may be of solid (i.e., non-hollow) construction while others may be of hollow construction. Additionally, some frame members may be thicker than others to provide the desired structural support for a particular embodiment. There may be additional supporting frame members other than the ones shown in FIG. 2 (e.g., crossing or parallel buttressing members), or the frame members may be arranged in different configurations The variations in configuration may allow for different embodiments to be lighter or heavier, more flexible or less flexible, and more quickly or more slowly inflatable.

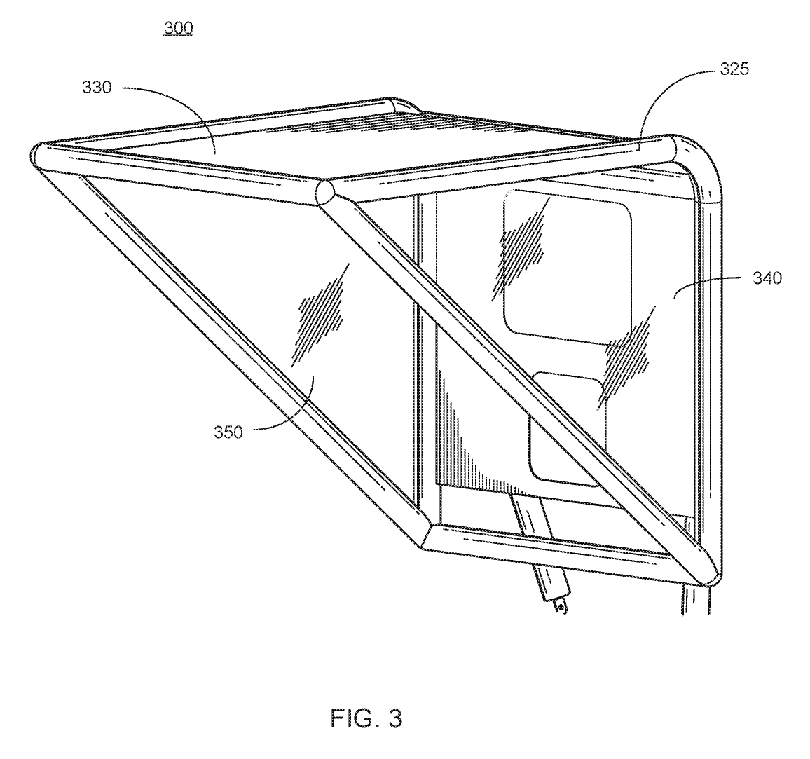

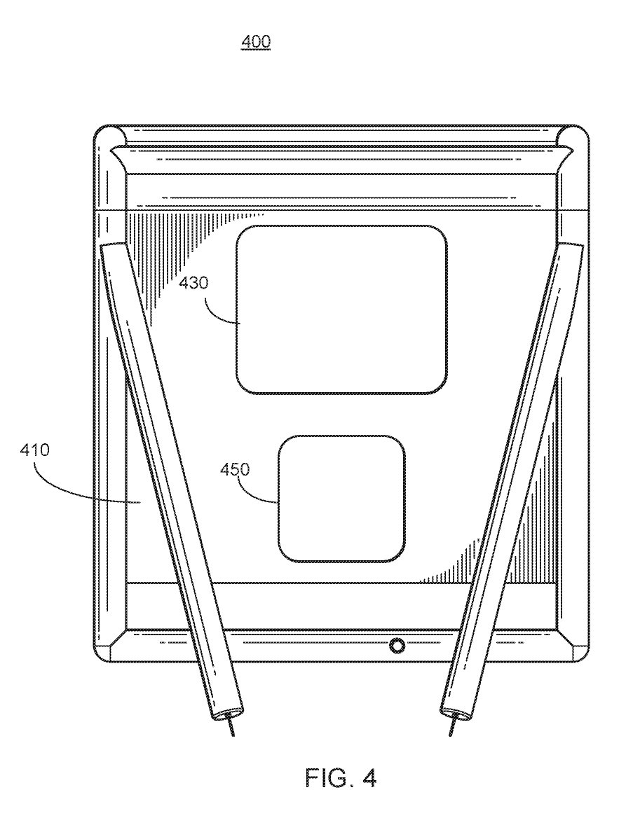

Turning now to FIG. 3, the canopy cover 200 of FIG. 2 is shown from a different perspective as canopy cover 300. The canopy cover 300 comprises several flexible panels between the tubes of the frame 325. A top shade panel 330 may comprise substantially or completely opaque material and provide shade for a user below. Referring briefly to FIG. 4, which shows the canopy cover 400 from a back elevation view, a back shade panel 410 may also comprise substantially or completely opaque material to provide shade from the direction it faces. The back shade panel 410 may also comprise a window 430 within the opaque material that is made of a translucent or transparent material. This window 430 may allow the golfer to stay in the shade and protection provided by the opaque material while walking with the cart while still being able to see where the golfer is walking. The back shade panel 450 may also comprise a cut-out opening 450. This cut-out opening 450 may be large enough for a golfer to reach his or her hand through and pull a golf club out of his or her bag. The opening 450 may provide the most convenient way to access the golf clubs while the canopy cover is in its inflated position. Because of the way the canopy system may be mounted on a particular golf cart, the canopy cover may sometimes be in the pathway through which golf clubs are usually taken out of the golf bag.

Turning back to FIG. 3, the canopy cover may further comprise side panels 340 and 350. These side panels 340 and 350 may be transparent or translucent, depending on the embodiment. They may also be interchangeable in some embodiments. Some embodiments may utilize translucent side panels that are somewhat dark and provide some shade while simultaneously allowing a golfer standing inside to see through them. The shade panels 330 and 410 (of FIG. 4), as well as side panels 340 and 350, may all be formed out of a flexible material that allows the entire canopy cover to collapse and be rolled up and stored when the frame is deflated. Any suitable flexible material may be used, such as fabric, plastic, or polymers. In some embodiments, thin PVC sheeting may be used.

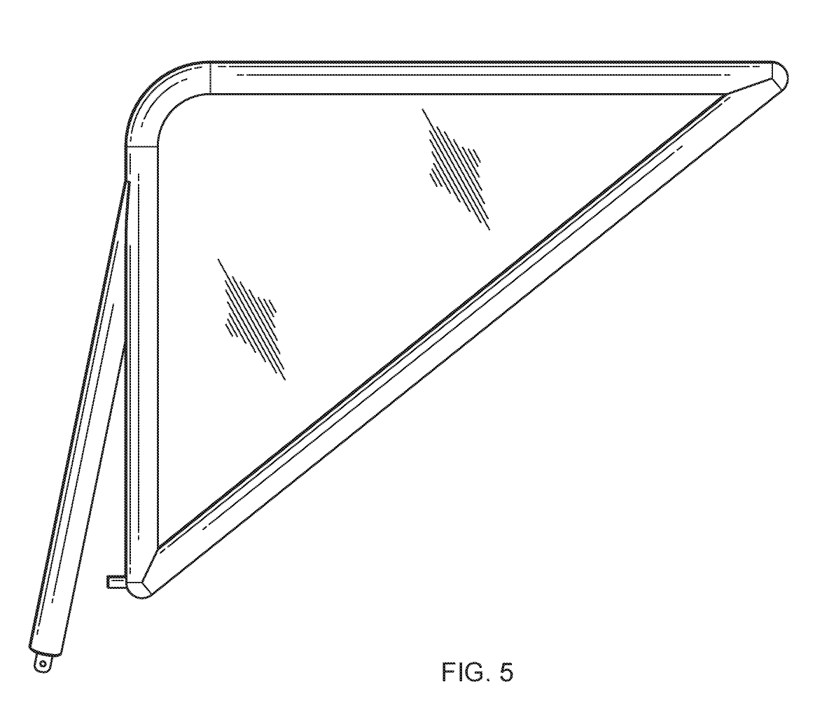

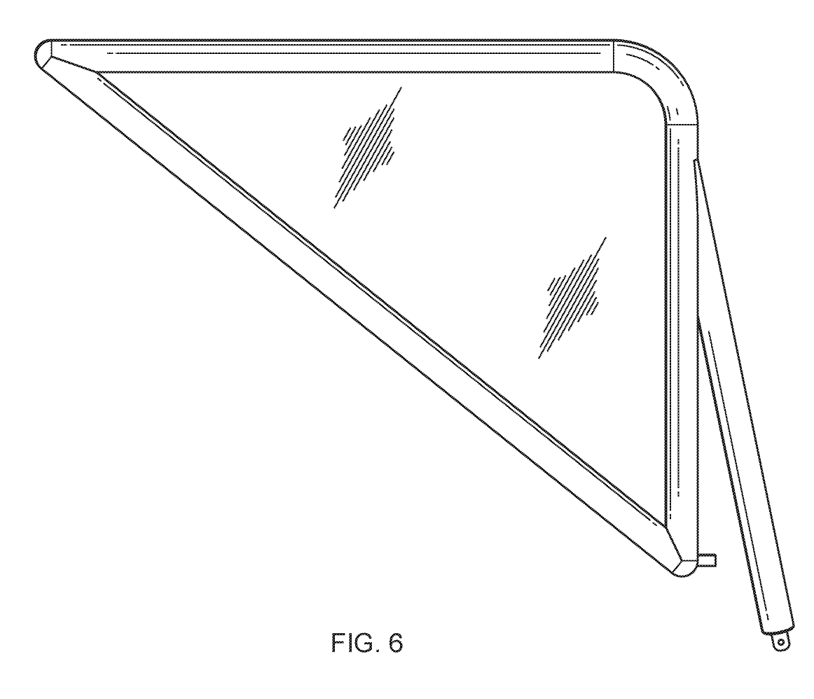

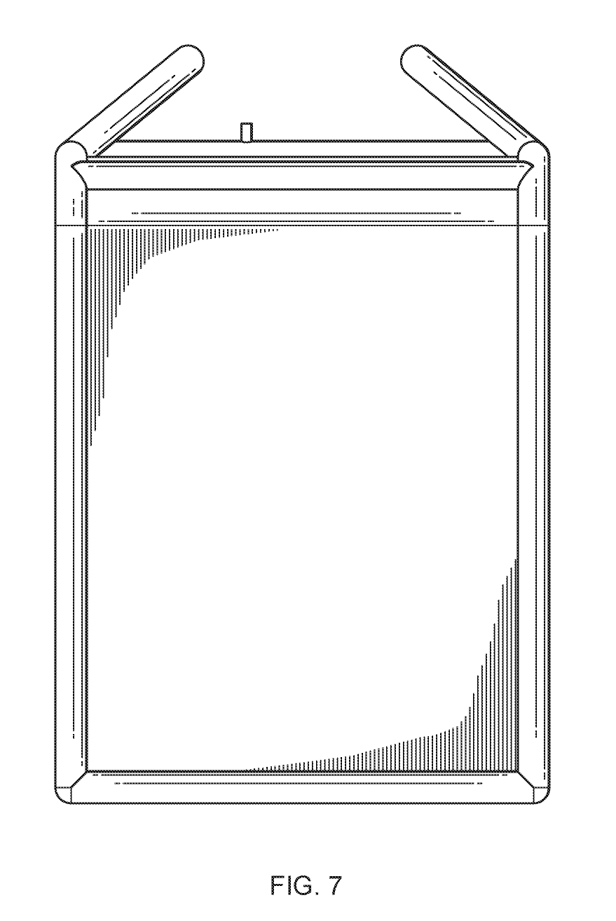

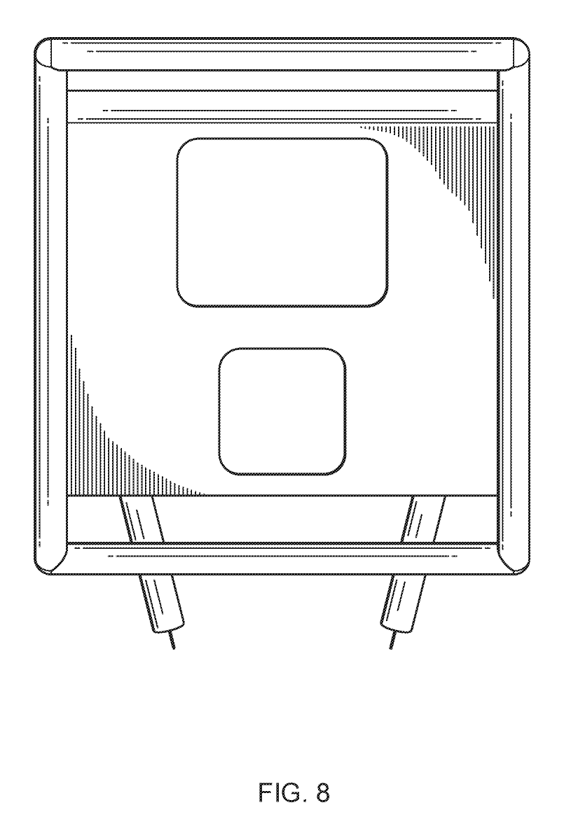

FIGS. 5 through 8 show the canopy cover of FIG. 2 from different perspectives for clarity. FIG. 5 shows a left side elevation view, FIG. 6 shows a mirror image right side elevation view, FIG. 7 shows a top plan view, and FIG. 8 shows a front elevation view. The canopy cover may be made in any suitable size, and may have a variety of shapes without departing from the disclosure. For example, some embodiments may have longer top panels or longer back panels; some may be rounded or curved; some may have only one diagonal frame member; and some may have detachable panels.

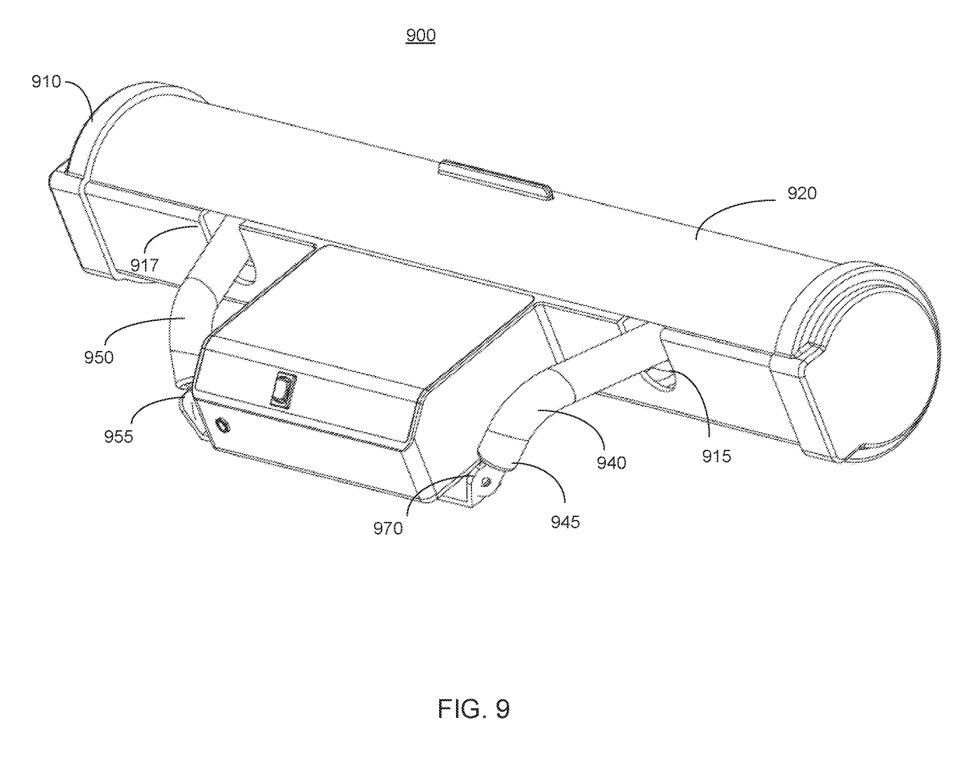

Another aspect of the present disclosure is an apparatus for inflation, deflation, and storage for the canopy cover. The apparatus may be referred to throughout this disclosure as a “canopy housing,” and may include mechanisms by which to attach the canopy cover to a handle of a golf cart (or any other object, such as a railing, pole, stand, other cart handle, etc.). FIG. 9 shows an embodiment of a canopy housing 900 in accordance with the present disclosure. In the embodiment shown, the canopy housing 900 comprises a substantially cylindrical body 910. The cylindrical body 910 may be attached to a top side of golf cart handle on its underside. The cylindrical body 910 may be attached using any suitable mechanism, such as hook-and-loop fabric straps, clamps, clips, buttons, or the like. Such attachment mechanisms may be suited to allow a user to install a canopy housing onto a variety of existing golf cart handles themselves, or may be specifically designed to fit a particular make and/or model of golf cart. The canopy housing and canopy cover together are designed to be lightweight, such that even when the canopy cover is fully extended and the golf cart is empty, the weight of the cart canopy would not cause the golf cart to tip or be imbalanced. In some embodiments, the mechanism for attachment to another object may include a mechanism for raising and lowering the height of the entire canopy system. Such mechanisms may include, for example, telescoping poles, springs, folding stands, pistons, or hydraulic lifts. In some embodiments, the mechanism for attachment to another object may include a rotating mechanism, such as a wheel with locking pins, to allow the entire canopy system to articulate forward and backward along an axis parallel to a longitudinal axis of the cylindrical body 910.

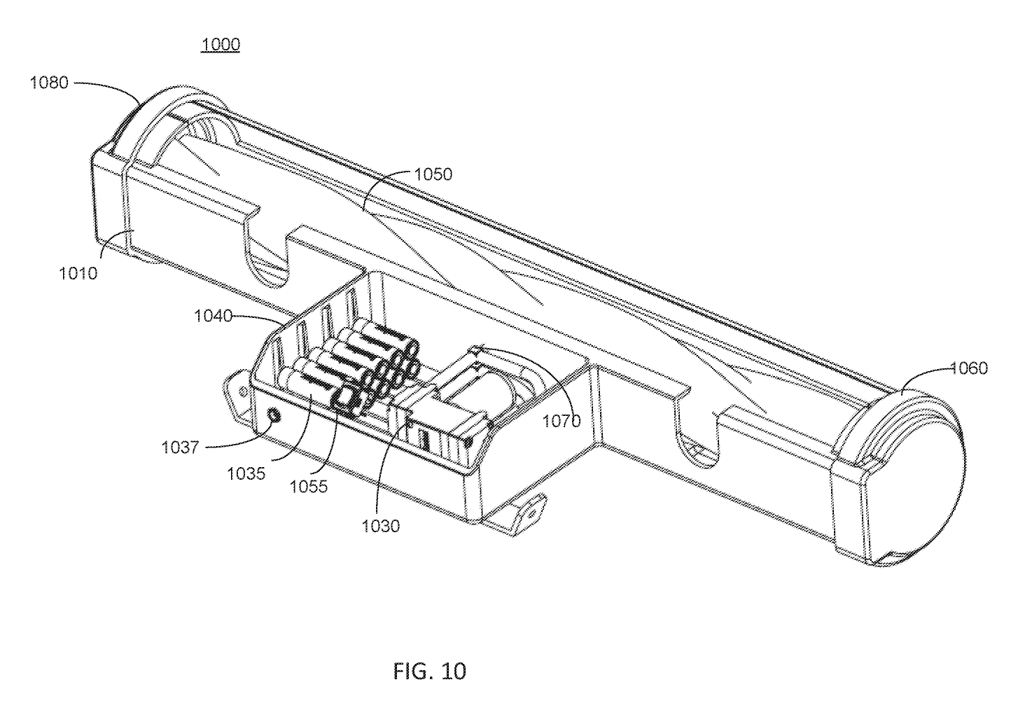

Still referring to FIG. 9, the canopy housing 900 comprises a top cover 920 that is configured to slide over the canopy cover when it is in a deflated and/or collapsed position and retained within the cylindrical body 910. In the embodiment shown, the top cover 920 may roll to the front, away from the mounting frame members 940 and 950. Referring briefly to FIG. 10, a rolled-up version of the canopy cover 1050 is shown with a top cover hidden from view. In some embodiments, the collapsed canopy cover may be manually rolled up and tucked into the cylindrical body. In other embodiments, the collapsed canopy cover may be automatically retracted into the cylindrical body 910. Such a retraction may be accomplished by, for example, a motorized roller, or a mechanical spring-loaded roller, which is not shown. The retraction could alternatively be accomplished by the automatic folding of the canopy cover structure as it gets deflated. Regardless of the mechanism by which the canopy cover is retracted, when the canopy cover is tucked within the cylindrical body 910, it may be retained by the top cover 920 sliding back over it. Because the canopy cover can be collapsed, retracted, and stored, the canopy housing 900 provides the benefit of being able to keep the canopy cover out of the way and protected from damage when it is not needed.

FIG. 9 shows how the mounting frame members 940 and 950 may attach to the canopy housing at respective base attachment ends 945 and 955. These base attachment ends 945 and 955 may attach to a mounting bracket 970 of the canopy housing 900. The mounting members 940 and 950 may protrude from the cylindrical body 910 through cut-outs 915 and 917.

Turning to FIG. 10, the canopy housing 1000 is shown with the top cover and a cover for an inflation mechanism housing 1040 removed. The mounting members 940 and 950 shown in FIG. 9 are not shown in FIG. 10. The canopy housing 1000 may also comprise an inflation mechanism 1030, such as a motorized (or, alternatively, manual) air pump. The inflation mechanism 1030 may push air into the canopy cover through one or more holes in one or more tubes of the canopy cover. In the embodiment shown, a hole 1070 through the cylindrical body 1010 allows the inflation mechanism 1030 to inflate the canopy cover 1050. It is contemplated that in various embodiments, the inflation hole or holes may be located in different places based on several factors, such as how quickly the canopy cover needs to be inflated or the particular configuration of the inflatable tubes of the canopy cover.

The inflation mechanism 1030, if motorized, may be battery-powered. FIG. 10 shows a battery pack 1035 that may comprise disposable or rechargeable batteries. If rechargeable batteries are used, the canopy housing may further comprise a charging port 1037. In some embodiments, one or more solar panels may be disposed on the canopy cover or canopy housing to provide power to charge the batteries. In some embodiments, the inflation mechanism may also be a deflation mechanism, such as a motorized air pump that runs in reverse and sucks the air out of the canopy cover. One or more buttons 1055 may be disposed on an outer surface of the canopy housing to initiate inflation and/or deflation, which allow for easy set up and take-down of the canopy cover 1050. In other embodiments, the canopy cover may be deflated simply by opening or uncovering one or more valves through which air can escape. In such embodiments, excess air may be forced out of the valve or valves when the canopy cover 1050 is manually or automatically rolled or retracted. The valves may be located in any place on the structure of the canopy to allow the air to escape efficiently.

The canopy housing 1000 may be composed of a substantially rigid, durable material that is suitable for protecting its components from weather or other damage. Suitable materials may include, but are not limited to plastics, metals, and polymers. Various materials may be chosen based on their desirable features, including, for example, their durability, lightness, and their properties when exposed to sunlight for prolonged periods of time. It is contemplated that a suitable material would not be very reflective, such as to avoid causing a glare, and would not retain excessive heat, such as to avoid being too hot to the touch. Further, a suitable material would be fairly resistant to damage from sun exposure, and would likely be waterproof.

The canopy housing 1000 may comprise various attachment points to the canopy housing 1000 for the structure of the canopy cover when it is fully extended or inflated. The attachment points may be in addition to any attachment points specifically for the inflation of the structure or the attachment points of the mounting members 940 and 950 shown in FIG. 9. The attachment points may be coupled to mechanisms for adjusting the position of the canopy cover separately from the canopy housing 1000 when fully extended. For example, the distal ends 1060 and 1080 of the canopy housing may comprise telescoping poles or other raising mechanisms for raising the entire canopy cover vertically, in order to adjust its height for taller users. The distal ends 1060 and 1080 may also comprise a rotating mechanism to allow the entire canopy cover to rotate downward.

The collapsible canopy and canopy system described in the present disclosure may advantageously allow a golfer to stand underneath the canopy protected from sun, wind, and other hazards. The canopy system itself may be lightweight, easy to install, easy to use, and quick to inflate, deflate, and store.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A collapsible protective canopy comprising:
a plurality of inflatable frame members, the frame members forming:
a rectangular top frame having a first end and a second end, and a rectangular back frame having a first end and a second end, the first end of the rectangular top frame being attached to the first end of the rectangular back frame;
at least one diagonal frame member attached to the second end of the rectangular top frame and the second end of the rectangular back frame; and
one or more flexible shade panels, wherein at least one of the flexible shade panels is disposed between the plurality of frame members forming the rectangular top frame.

2. The collapsible protective canopy of claim 1, wherein at least one of the flexible shade panels is disposed between the plurality of frame members forming the rectangular back frame.

3. The collapsible protective canopy of claim 1 further comprising:
one or more flexible side panels disposed between the at least one diagonal frame member, the rectangular top frame, and the rectangular back frame.

4. The collapsible protective canopy of claim 1, wherein at least one of the one or more flexible shade panels is opaque.

5. The collapsible protective canopy of claim 3, wherein the one or more flexible side panels is translucent.

6. The collapsible protective canopy of claim 1, wherein the one or more flexible shade panels is opaque and comprises a translucent viewing window.

7. The collapsible protective canopy of claim 1, wherein the one or more flexible shade panels is opaque and comprises an opening.

8. The collapsible protective canopy of claim 1, further comprising two mounting frame members, each of the mounting frame members having a frame attachment end and a base attachment end, and wherein the two mounting frame members are each attached to the rectangular back frame at the frame attachment ends and configured to attach to a base at the base attachment ends.

9. The collapsible protective canopy of claim 1, wherein each of the plurality of frame members and the at least one diagonal frame member are inflatable.

10. The collapsible protective canopy of claim 9, wherein each of the plurality of frame members and the at least one diagonal frame member are connected such that each of the plurality of frame members and the at least one diagonal frame members can be inflated through one air source.

11. A collapsible canopy system comprising:
an inflatable canopy cover comprising:
a plurality of inflatable frame members, the frame members forming:
a top frame having a first end and a second end, and a back frame having a first end and a second end, the first end of the top frame being attached to the first end of the back frame;
one or more flexible shade panels, wherein at least one of the flexible shade panels is disposed between the plurality of frame members forming the top frame;
a canopy housing comprising:
an air pump configured to pump air into at least a portion of the inflatable canopy cover,
a mechanism for attaching the canopy housing to another object, and
a storage compartment configured to retain the inflatable canopy cover when it is in a deflated state.

11. The collapsible canopy system of claim 10, wherein the air pump is mechanical.

12. The collapsible canopy system of claim 11, wherein the air pump is battery-operated.

13. The collapsible canopy system of claim 12, wherein the battery-operated air pump is rechargeable.

14. The collapsible canopy system of claim 13, further comprising one or more solar panels configured to charge the battery-operated air pump.

15. The collapsible canopy system of claim 10, wherein the storage compartment further comprises a sliding top cover configured to cover the inflatable canopy when the inflatable canopy is in the deflated state and retract when the inflatable canopy is in an inflated state.

16. The collapsible canopy system of claim 10, wherein the canopy housing further comprises an adjustable structure configured to adjust a distance between the canopy cover and the canopy housing such that the height of the canopy cover can be increased or decreased when in an inflated state.

17. The collapsible canopy system of claim 11, wherein the mechanical air pump is configured to mechanically deflate the inflatable canopy cover.

18. The collapsible canopy system of claim 10, wherein the canopy housing further comprises a mechanism to automatically retract the canopy cover into the canopy housing.

19. The collapsible canopy system of claim 11, further comprising a button to activate the mechanical air pump and automatically inflate the canopy cover.

20. The collapsible canopy system of claim 10, wherein the mechanism for attaching the canopy housing is configured to attach to a golf cart handle.
